(19) United States
(12) Patent Application Publication
(10) Pub. No.: US 2011/0020639 A1
(43) Pub. Date: Jan. 27, 2011

(54) PLASTIC LAMINATE AND METHOD FOR MAKING THE PLASTIC LAMINATE

(75) Inventors: SHU-HAI PENG, Shenzhen City (CN); JIAN-BIN DENG, Shenzhen City (CN); BO LIU, Shenzhen City (CN); QING-MING YUAN, Shenzhen City (CN); JIANG YU, Shenzhen City (CN); YE SUN, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/749,641

(22) Filed: Mar. 30, 2010

(30) Foreign Application Priority Data
Jul. 21, 2009 (CN) 200910304587.4

(51) Int. Cl. B32B 27/08; B32B 5/00; B32B 37/24

(52) U.S. Cl. 428/337; 428/516; 428/339; 156/242

(57) ABSTRACT

A plastic laminate comprises a main layer and an abrasion resistant layer formed on the main layer. The main layer is made of polystyrene. The abrasion resistant layer is made of polypropylene and additives. A method for making the plastic laminate is also described there.

### BACKGROUND

1. Technical Field

The present disclosure relates to plastic laminates, especially to a plastic laminate having high abrasion resistance and a method for making the plastic laminate.

2. Description of Related Art

Polystyrene is now widely used to manufacture packing laminates for packing electronic devices. However, polystyrene laminates have low abrasion resistance, and if damaged during transport of electronic devices may allow contamination of the electronic devices.

Therefore, there is room for improvement within the art.

### BRIEF DESCRIPTION OF THE FIGURES

Many aspects of the plastic laminate can be better understood with reference to the following figures. The components in the figures are not necessarily drawn to scale, the emphasis instead being placed upon clearly illustrating the principles of the plastic laminate.

FIG. 1 is a cross-sectional view of an exemplary embodiment of a plastic laminate.

FIG. 2 is a flowchart of an exemplary embodiment of making the plastic laminate shown in FIG. 1.

### DETAILED DESCRIPTION

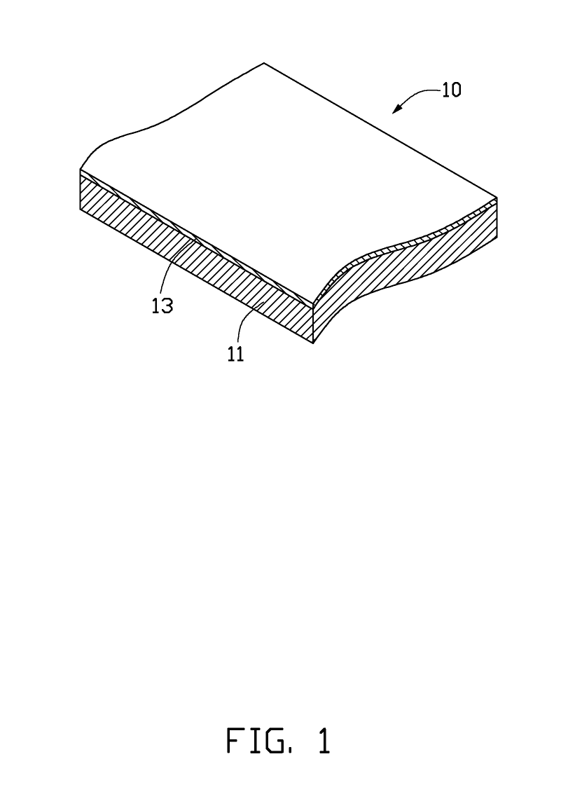

Referring to FIG. 1, in this exemplary embodiment, a plastic laminate 10 includes a main layer 11 and an abrasion resistant layer 13 formed on the main layer 11.

The main layer 11 may be made primarily of polystyrene resin, with other common laminate additives, such as talc. The main layer 11 may have a thickness of about 0.8-0.9 mm. The polystyrene resin may have a 55-65% percent by weight in the plastic laminate 10.

The abrasion resistant layer 13 may be made primarily of polypropylene resin, with other additives, such as stearic acid, zinc stearate, and colorant. The mass ratio of the polypropylene resin, the stearic acid, the zinc stearate and the colorant may be about 25˜30:3˜8:0.01˜0.2:0.01˜0.5. The polypropylene resin with its high abrasion resistance, together with the added stearic acid and the zinc stearate give the plastic laminate 10 even better abrasion resistance and durability. The abrasion resistant layer 13 may have a thickness of about 0.05-0.1 mm. Commonly, the thickness of the abrasion resistant layer 13 is less than the thickness of the main layer 11.

A main advantage of the plastic laminate 10 is that, due to the excellent abrasion resistance and durability of the abrasion resistant layer 13, the plastic laminate 10 has excellent surface abrasion resistance, and the presence of the abrasion resistant layer 13 can prevent particles in the plastic laminate 10 from being excessively scraped off.

A method for manufacturing a plastic laminate, in this exemplary embodiment, may include: heating a predetermined quantity of polystyrene until melted; forming the melted polystyrene into a main layer; heating a predetermined quantity of a mixture of polypropylene and additives until melted; forming the melted mixture into an abrasion resistant layer; and rolling the main layer and the abrasion resistant layer into an integrated unit to form the plastic laminate.

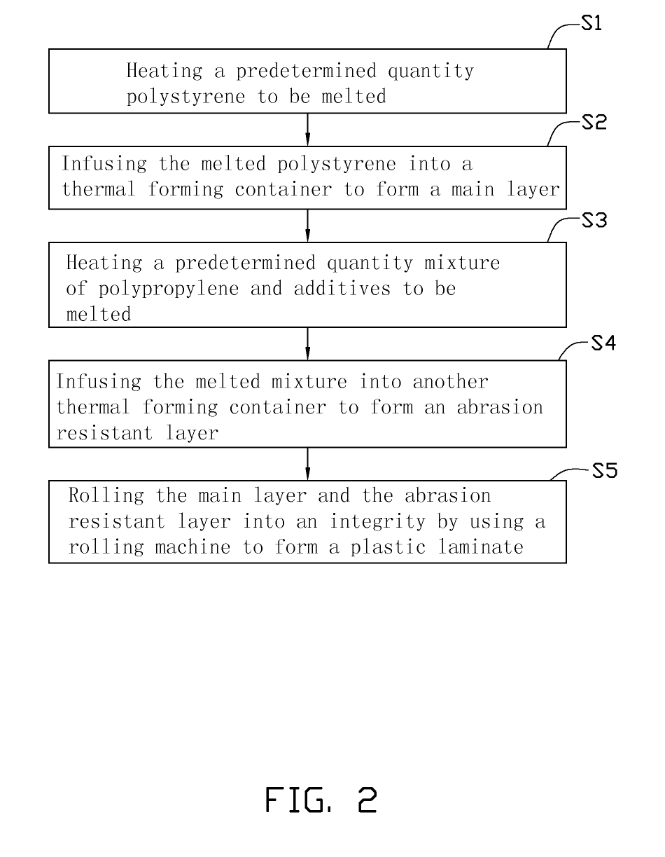

Referring to FIG. 2, a method for manufacturing the plastic laminate 10, in this exemplary embodiment, may include steps S1-S5.

In step S1, a predetermined quantity of polystyrene is provided and then heated until melted. Commonly, talc can be added into the polystyrene to allow the polystyrene to be more easily shaped.

In step S2, a thermal forming container is provided. The thermal forming container may have a level bottom surface. The melted polystyrene and talc is then infused into the thermal forming container and subsequently cooled to form the main layer 11.

In step S3, a predetermined quantity of a mixture of polypropylene and additives is heated until melted. The additives can be stearic acid, zinc stearate, and colorant. The mass ratio of the polypropylene resin, the stearic acid, the zinc stearate and the colorant may be about 25˜30:3˜8:0.01˜0.2:0.01˜0.5.

In step S4, another thermal forming container is provided. The melted mixture from step S3 is then infused into this thermal forming container and subsequently cooled to form the abrasion resistant layer 13.

In step S5, a rolling machine is provided. The main layer 11 and the abrasion resistant layer 13 are then rolled together by the rolling machine to form the plastic laminate 10.

It should be understood, the step S1 and the step S3 can be carried out at the same time; and step S2 and step S4 can be carried out at the same time

The plastic laminate 10 can be used to form, for example, a packing laminate, such as a packet, a cushion, or a pallet.

An abrasion resistance test was performed on the plastic laminate 10. The test was carried out by rotating a grinding wheel 1000 times against the surface of the abrasion resistant layer 13 under a load of 1000 grams. The test resulted in about 6-8 mg of scrap of the abrasion resistant layer 13, which is substantially less than the 50-65 mg of scrap of conventional polystyrene laminate using the same testing conditions.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A plastic laminate, comprising:
a main layer made of polystyrene; and
an abrasion resistant layer formed on the main layer, the abrasion resistant layer being made of polypropylene and additives.

2. The plastic laminate as claimed in claim 1, wherein the additives include stearic acid, zinc stearate, and colorant.

3. The plastic laminate as claimed in claim 2, wherein the mass ratio of the polypropylene resin, the stearic acid, the zinc stearate and the colorant is about 25˜30:3˜8:0.01˜0.2:0.01˜0.5.

4. The plastic laminate as claimed in claim 1, wherein the polystyrene has about 55-65% percent by weight in the plastic laminate.

5. The plastic laminate as claimed in claim 1, wherein the main layer has a thickness of about 0.8-0.9 mm.

6. The plastic laminate as claimed in claim 1, wherein the abrasion resistant layer has a thickness of about 0.05-0.1 mm.

7. The plastic laminate as claimed in claim 1, wherein the main layer further includes talc.

8. A method for making a plastic laminate, comprising:
heating a predetermined quantity of polystyrene until melted;
forming the melted polystyrene into a main layer;
heating a predetermined quantity of a mixture of polypropylene and additives until melted;
forming the melted mixture into an abrasion resistant layer; and
rolling the main layer and the abrasion resistant layer into an integrated unit to form the plastic laminate.

9. The method as claimed in claim 8, wherein the additives include stearic acid, zinc stearate, and colorant.

10. The method as claimed in claim 9, wherein the mass ratio of the polypropylene resin, the stearic acid, the zinc stearate and the colorant is about 25˜30:3˜8:0.01˜0.2:0.01˜0.5.

11. The method as claimed in claim 8, wherein the polystyrene has about 55-65% percent by weight in the plastic laminate.

12. The method as claimed in claim 8, wherein the main layer has a thickness of about 0.8-0.9 mm.

13. The method as claimed in claim 8, wherein the abrasion resistant layer has a thickness of about 0.05-0.1 mm.

14. A method for making a plastic laminate, comprising:
heating a predetermined quantity of polystyrene until melted;
heating a predetermined quantity of a mixture of polypropylene and additives until melted;
forming the melted polystyrene into a main layer;
forming the melted mixture into an abrasion resistant layer; and
rolling the main layer and the abrasion resistant layer into an integrated unit to form the plastic laminate.
